(19) United States
(12) Patent Application Publication
(10) Pub. No.: US 2005/0284117 A1
(43) Pub. Date: Dec. 29, 2005

(54) Particle filter

(76) Inventor: Helmut Swars, Bergisch Gladbach (DE)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/004,048

(22) Filed: Dec. 3, 2004

(30) Foreign Application Priority Data
Dec. 3, 2003 (DE) 103 56 997.9

(51) Int. Cl. B01D 46/00

(52) U.S. Cl. 55/497

(57) ABSTRACT

The invention relates to a particle filter with a plurality of filter walls with filter surfaces to be flowed through, where the filter displays an inflow side and an outflow side and the filter can be flowed through in one direction of flow, where the filter walls consist of a fabric that can be structured by deformation and are connected to each other in at least essentially particle-tight fashion on the inflow side and the outflow side of the filter. In the particle filter, a plurality of filter walls is formed by a continuous strip of filter material deposited into a three-dimensional body, forming deflection areas.

The invention relates to a particle filter, especially for exhaust gases of diesel-fuelled internal-combustion engines, with a plurality of filter walls to be flowed through, with filter surfaces made of filter material that are permeable to a fluid and essentially impermeable to particles entrained by it, where the filter displays an inflow side and an outflow side and the filter can be flowed through in one direction of flow, where the filter walls consist of a fabric that can be structured by deformation and are connected to each other in at least essentially particle-tight fashion on the inflow side and the outflow side of the filter.

Particle filters of this kind, which are particularly used in the form of soot filters to clean exhaust gases of diesel-fuelled internal-combustion engines, are mostly used to clean fluid, gaseous media of entrained particles. General particle filters can thus also be used in other fields of gas purification, such as in the purification of other combustion gases or exhaust gases from technological processes. Where appropriate, however, the fluid media can also be liquid media.

Particle filters with ceramic filter elements are known, but these generally display the disadvantage of lower thermal shock resistance, as well as other disadvantages existing when using ceramic materials, such as brittleness and other disadvantages in relation to handling.

Further, particle filters consisting of stacked filter plates are known, where the filter plates can display structuring, deformable structures, such as metal grids, that are coated with suitable filter material in order to be able to define the filter properties, especially as regards permeability or impermeability to particles of a given size or shape. It goes without saying, however, that the invention is not limited to particle filters with filter plates constructed in this manner, insofar as the filter material forming the walls can be sufficiently structured, while still retaining adequate structural strength for the application in question, by deformation, particularly by mechanical deformation, mostly by stacking a plurality of filter plates on top of each other.

In particle filters of this kind with a plurality of stacked filter plates, adjacent filter plates have to be connected to each other at their peripheral edges or contact areas, e.g. by forming welded connections. The production of welded connections of this kind is not only a complex and time-consuming process, it also leads to increased lack of fusion and rejects. Further, owing to the thermal shock resistance requirements of the particle filter, for instance when used as a soot filter in diesel-fuelled motor vehicles, parting of the weld seams of the relatively thin filter plates is to be feared over extended periods of time, this possibly resulting in leaks and thus malfunctioning of the particle filter. Further, the production of large numbers of individual filter walls, which then have to be joined to form a particle filter, is a relatively complex and expensive process.

Therefore, the object of the invention is to create a particle filter that can be manufactured easily and inexpensively, and that displays great tightness and, consequently, a dependable filter effect in relation to the particles to be separated.

The object is solved by a particle filter in which, according to the invention, the plurality of filter walls of the filter, or of a filter segment displaying a plurality of filter walls, is formed by a continuous strip of filter material that is deposited to form a three-dimensional body, forming deflection areas in the process. As a result of the fact that a plurality of filter walls can be provided by a coherent, continuous strip by suitably depositing or folding the strip, the particle filter, or a filter segment displaying a plurality of filter walls, is not only easy to manufacture, but also eliminates the need to produce a plurality of joints, such as are required for connecting conventional filter plates to create a filter body. In the particle filter according to the invention, joints between individual filter walls are provided by the deflection areas of the one-piece strip of filter material, meaning that, in this case, the joints at the individual abutting areas of adjacent filter walls can display a substantially smaller expansion, or be very largely dispensed with, at least in the deflection areas, or in general. Further, continuous production of the filter from a strip-like filter material is virtually possible, this greatly simplifying manufacture. In this context, the filter can be assembled from 2 to 5 filter segments, without being limited to this, although the filter preferably consists of just one, coherent segment.

Preferably, the connections between adjacent filter walls are provided by deflection areas of the continuous strip of filter material, both on the inflow side and the outflow side of the filter, meaning that separate joining processes can be very largely or fully dispensed with, particularly in the deflection areas or on the filter as a whole. However, special advantages are already obtained if just some of the joints between adjacent filter walls can be dispensed with, this in itself simplifying production and permitting a substantial improvement in the reliability of the particle filter over a long service life. Since, by means of deflection areas of the continuous, preferably one-piece strip, which likewise forms the filter walls, the particle filter is designed to be continuous and preferably without incisions or recesses in the transitional areas between adjacent filter walls, high media-tightness of the particle filter can be achieved. The deflection areas can be of more or less angular or curved design, for instance also in the form of folds of the continuous, preferably one-piece strip of filter material.

Connecting areas of strip areas can be disposed in such a way that the fluid pressure does not directly stress the joints, e.g. by designing the connections as folds.

The filter is preferably designed in such a way that the deflection areas of the deposited strip constitute areas flowed against by the fluid medium to be cleaned and, in this context, deflect the flow of said fluid and/or have a filter effect.

Where appropriate, it is also possible for only an inflow-side and/or outflow-side area of the filter to be constructed from a strip deposited or folded with a corresponding structure, thus avoiding joining areas of the filter walls at the face ends of the filter, this already bringing about a certain improvement.

Where appropriate, the continuous strip can display two or more strip sections connected to each other in essentially particle-tight, or preferably tensile force-absorbing, fashion, along a joining line preferably running essentially parallel to the longitudinal direction of the strip, for instance by means of a welded or folded seam connection. The joining line can have the length of the strip or, where appropriate, also be shorter, if running at an angle to the longitudinal direction of the strip, e.g. an angle of <45° or <60° or 75°, such that several joining lines follow each other a distance apart in the longitudinal direction of the strip. Since the joining line runs essentially in the longitudinal direction of the strip, joints extending over a relatively large area of the face end of the filter in the deflection areas of the strip are avoided.

Preferably, the continuous strip is in each case of one-piece design, at least over the width by which the filter area of the filter flowed through by the fluid medium is formed when the strip is deposited, or over the full width of the strip. The strip is preferably also of one-piece design over its full length. Where appropriate, joints can be located roughly at the level of the side walls of the filter, or in the area of the strip located laterally to the through-flow area of the filter, for instance by forming a filter side wall by bending down the filter wall. The lateral areas of the strip can thus display different characteristics, e.g. in order to permit simpler or more stable fastening to a housing.

Preferably, all filter walls of the particle filter are formed by a single, continuous, preferably one-piece strip of filter material. Where appropriate, however, the particle filter can also comprise several filter segments, each of which displays a plurality of filter walls, where each segment of the particle filter is formed by a one-piece strip, shaped or deposited in appropriate fashion to produce a filter body. The segments can be positioned above and/or alongside each other to form the filter. The segments can be separated by housing components or the like, although they can also be connected to form a coherent filter body, e.g. by joining together the respective end areas of the filter material strips of different segments.

The particle filter is preferably formed by a continuous, particularly one-piece, strip of filter material, which is deposited in meandering fashion, forming a three-dimensional body. Depositing in meandering fashion very largely avoids joints between adjacent filter surfaces. Three-dimensional bodies of this kind, made of strip-like material deposited in meandering fashion, can produce individual segments of a particle filter, or the entire filter body of the particle filter.

Alternatively, a particle filter with a plurality of filter walls, made of a continuous, particularly one-piece, strip of filter material, can, for example, also be manufactured by the strip being folded along a folding line running in the longitudinal direction of the strip, forming double layers, where the folding line is preferably the center line of the strip, where the two strip halves display a certain gap between each other on the opposite longitudinal edges of the arrow, and where the slightly spread strip is subsequently wound around a central axis in helical or worm-like fashion. The central axis can be provided by a component, such as a longitudinal rod, or it can be a virtual axis. The curving of the strip in the winding direction can, for example, be made possible by certain areas of the strip being folded together or gathered, where the folding lines run essentially perpendicularly to the longitudinal axis of the strip. Particle filters of this kind can be produced for specific applications, although their manufacture is more complex compared to particle filters with a filter strip deposited in meandering fashion.

Advantageously, all the filter walls of the filter are formed by a one-piece strip of filter material deposited in a suitable manner. This can refer to the entire filter body, or to the area of the same having a filter effect if lateral strips made of another material are provided to form lateral filter walls. Where appropriate, it is also possible to construct only one filter segment in this way, where the particle filter can consist of several interconnected segments, these being arranged next to or behind each other in the direction of flow.

Particularly preferably, the deflection areas of the one-piece strip of filter material extend continuously over at least the full extension of the filter in the direction of flow or a direction transverse to it. In this way, incisions in the filter material strip, especially linear incisions, which would necessitate further joining steps, such as welded connections, can be virtually completely avoided. The longitudinal extension of the deflection areas preferably extends in a direction transverse, particularly perpendicular, to the longitudinal direction of the strip. If the strip is folded along a folding line running parallel to the longitudinal axis of the strip, the deflection areas can extend in the longitudinal direction of the strip. In this way, adjacent filter walls are continuously connected to each other by the integrally molded deflection areas.

According to a particularly preferred embodiment, the filter material strip deposited in meandering fashion is deposited in such a way that its longitudinal direction runs essentially, or exactly, parallel to the direction of flow of the fluid medium. As a result, a particle filter can be produced, in which all filter walls of the particle filter, or of a segment thereof, where appropriate, are interconnected by deflection areas of the filter material strip that extend preferably transversely, or essentially perpendicularly, to the direction of flow of the fluid medium, where all transitional areas between adjacent filter walls are formed by deflection areas integrally connected to them. As a result, additional joining measures, especially along face-end joining lines, for connecting the filter walls can be dispensed with completely. At the same time, the deflection areas can easily be provided with suitable profiles, in order to stabilize the inflow and/or outflow areas of the filter and/or to create favorable flow conditions.

Alternatively, the particle filter can, for example, also be produced from a coherent, preferably one-piece filter material strip by the strip being folded along at least one folding line running essentially parallel to the longitudinal direction of the strip, forming at least a double layer, and subsequently deposited in meandering fashion in such a way that the longitudinal direction of the strip runs transversely, preferably perpendicularly, to the direction of flow of the fluid medium. The folding line running in the longitudinal direction of the strip can then be located on the inflow side or the outflow side. Folding along the folding line in the longitudinal direction of the strip thus creates two sets of filter walls, which are initially of essentially the same length in the direction of flow. Where appropriate, the filter material strip can also be folded in several layers along a folding line running in the longitudinal direction, e.g. by folding three times, thereby producing a strip with four sets of filter walls, corresponding to four strips of the strip-like material. After the strip has been deposited in meandering fashion, adjacent longitudinal edges of the strip, which are assigned to different double layers referred to the folding line of the strip, can be connected to each other, preferably by folding over edge areas of the strip around the edge of an adjacent filter wall. Given a suitable filter material strip, sufficiently stable connection to an edge section of an adjacent filter wall can already be obtained by folding over an edge area, where folding is preferably performed in such a way that sufficiently particle-tight connection of the edge areas of adjacent filter walls is already achieved, meaning that additional joining procedures, such as the production of welded connections, can be dispensed with completely, although, where appropriate, provision can also be made, alternatively or additionally, for further joining procedures of this kind, such as welding.

The folding line running in the longitudinal direction of the strip is advantageously oriented parallel to the longitudinal axis of the strip, meaning that the edges of adjacent filter walls are then positioned parallel to each other.

If the folding line running parallel to the longitudinal direction of the strip is located eccentrically, meaning that adjacent filter walls have different extensions starting from the folding line, the projecting edge area of one filter wall can be folded around the edge of a filter wall of an adjacent double layer, meaning that, preferably, only a triple layer of the filter material strip is produced in the connecting area.

Preferably, the width of the filter material strip is dimensioned in such a way that it exceeds the width of the filter or filter segment produced by depositing the strip in suitable, three-dimensional fashion, at least over part of the length, or preferably the full length, of the strip, where edge areas of the strip are bent over on at least one, or both, of the lateral strip edges relative to the direction of extension of the filter wall formed by a strip section. The edge areas are thus bent over in the direction of a side wall of the filter or filter segment that is located between the inflow side and the outflow side of the filter. As a result of these bends, connections can be produced between different filter walls, where the connections can be produced by non-positive and/or positive and/or material means, such as by forming folded seams or also by welded connections. The connections can in each case be made between adjacent filter walls or also, additionally or alternatively, between further adjacent filter walls, meaning that the bent areas can also extend over three, four or more layers of adjacent filter walls. Connections of this kind can substantially increase the dimensional stability of the particle filter. Further, bent areas of this kind can be used to construct one or both side walls of the filter, where the bent areas extend over part, preferably the middle part, of the filter or filter segment, preferably over the full extension of the filter or filter segment, in the direction of flow. Leaks can be avoided by means of bends of this kind, particularly also in the edge areas of the filter walls. At the same time, bent areas of this kind can serve to fix stiffening elements or catalytically active elements, described further below, in place on the particle filter, e.g. by clamping end areas of the elements mentioned between adjacent, bent areas of the filter material strip. The bent areas can, in particular, be bent to form double layers. The bent areas preferably lie flat against the corresponding side wall of the particle filter and, where appropriate, the bent areas can also be connected to each other by folded seam connections by folding over edge areas of the filter material strip. The bent areas of the filter material strip are preferably connected in at least essentially, or completely, particle-tight fashion.

For the purposes of this application, the term “particle-tight” is to be taken as meaning that the filter walls in each case retain the particles to be removed in accordance with the intended use whose size exceeds a threshold value.

In the areas of the particle filter where double layers of the filter material strip are formed, notches can be provided in one layer of the strip, preserving one continuous filter wall, where the notches are bent out of the layer of the strip towards an adjacent filter wall and thus project from the notched filter wall. Notches of this kind can serve to fasten a filter wall on an opposite filter wall, e.g. by clamping the notched area in a fold of the opposite filter wall. Alternatively or additionally, notches of this kind can also serve to fix other elements of the particle filter in place, such as the stiffening elements, catalytically active elements or the like, described below. The double layers at the level of the notched areas are preferably designed in such a way that the adjacent layer of the filter material strip seals off the recess produced by notching more or less completely, preferably in particle-tight fashion. The doubled layers of the filter material strip thus lie closely against the layer of strip material containing the notch in the area of the notches, or at least in an adjacent area surrounding the perimeter of the notch.

In corresponding fashion, notches can additionally or alternatively be provided on double layers, which at least partly, or completely, form a side wall of the particle filter or connect two or more filter walls to each other. Notches of this kind can, in particular, be provided for fixing the particle filter in place in a housing accommodating the filter. To fix the particle filter in place on the housing, the notches can be fastened to the housing in positive or non-positive fashion, e.g. by clamping on certain areas of the housing that can, for example, be designed in the form of pockets or dents. Where appropriate, the notches can additionally or alternatively be fixed in place on the housing by material connections, e.g. by welded connections.

The continuous strip of filter material is preferably designed to be in one piece, at least in the area of the strip having a filter effect. Where appropriate, strips of sheet-metal material can also be integrally molded on one or both sides of the strip of filter material, which is preferably of one-part design in this context, over part of the length of the strip or continuously over the full length of the strip. The sheet-metal material is essentially or completely impermeable to the fluid, and it goes without saying that a different, suitable material can be used, where appropriate. The connection of the filter material strip to the lateral sheet-metal strips can be realized by a material connection, e.g. by a welded connection, or by a non-positive and/or positive connection, such as a folded seam connection. Edge areas of the strip, by means of which side walls of the filter are constructed or sheet-metal layers are connected to each other, for example, must thus no longer consist of comparatively expensive and hard-to-handle filter material. In the particle filter produced, the connecting areas between the filter material and the lateral edge strips of the strip are preferably located on the outside, adjacent to the area of the filter having a filter effect, e.g. at the level of the transitional area between the filter walls and the side walls, or the transitional areas are integrated within the side walls.

The filter preferably displays slits, which extend over at least part of the length, or essentially the full length, and at least essentially the full width of the filter, this making its regeneration particularly simple, e.g. by purging with purging gases in a direction transverse to the direction of flow of the fluid to be cleaned. The slit height can be ≧10%, ≧25% or 50%, preferably ≧75%, preferably approx. 100% of the mean or maximum wall spacing of adjacent filter walls. The slits can, for example, be produced by alternately depositing inversely structured filter walls, or by indentations of wave backs or ribs of filter walls.

Preferably, some or all of the filter walls display a structure in the form of ribs extending essentially in the direction of flow, which extend over part, e.g. at least one-quarter, at least half, or preferably essentially the whole of the extension of the filter in the direction of flow. These structures make it possible to increase both the effective filter area and the stability of the filter walls. Structuring is preferably accomplished by stamping or deformation of the filter strip material, particularly in the manner of folding or wave-like structuring of the filter material strip. To this end, the strip can, for example, be folded in zigzag fashion, where the resultant ribs run essentially in the longitudinal direction of the strip, or enclose a small angle with it. Structuring of the strip to form ribs is preferably performed in such a way that the ribs reduce the width of the strip uniformly over its full length.

Adjacent filter walls can be structured in such a way that the filter walls following each other transversely to the direction of flow, which are preferably stacked on top of each other in essentially parallel fashion in this direction, are arranged essentially congruently or inversely to each other. Where appropriate, however, adjacent filter walls can also have different, i.e. non-congruent, structures, making it possible to influence the flow conditions. Where appropriate, however, a non-compatible design of adjacent filter walls is also possible.

If adjacent filter walls are structured, forming filter wall spacings that preferably change in alternating fashion, where the structure can be regular or irregular, the deflection areas of the strip material are preferably located in the area of relatively large distances between the filter walls, forming indentations receding into the interior of the filter. As a result, reshaping of the filter material strip can be performed without compression or elongation, this being advantageous in the case of non-ductile filter wall material, in particular. With this arrangement, the filter walls can, in particular, be structured inversely relative to each other.

Adjacent filter walls are preferably structured to form ribs running essentially in the direction of flow, where the ribs can be essentially folded in zigzag fashion, designed in the form of filter wall corrugations, or of other design, where adjacent filter walls are deposited consecutively on top of each other in the manner of a stack and a distance apart in a stacking direction, where flat areas are provided that reduce the filter wall spacing, these being located on the face end of the filter and designed in the form of indentations extending into the interior of the filter. These indentations are preferably formed on deflection areas of the filter material strip, which connect adjacent filter walls to each other continuously or in one piece. Indentations of this kind are preferably provided if adjacent filter walls have congruent structures.

The flat areas can, in particular, be designed in such a way that the adjacent filter walls are only a slight distance apart, e.g. up to five times, or up to once or twice, the filter wall thickness, adjacent filter walls preferably making flat contact with each other in the region of the flat areas. Where appropriate, the flattened areas of the filter walls can be positioned obliquely at a certain angle to the main direction of extension of the associated filter walls, this resulting in favorable flow conditions in the event of angular flow against the filter.

The flat areas of adjacent filter walls, which can, in particular, be provided in the deflection area of the filter strip material, forming double layers, preferably have a wave-like or zigzag profile in the direction of extension of the filter walls, or in the direction of flow through the filter, meaning that flat areas displaying lesser and greater extension into the interior of the filter are present. The contour of the boundary line of the flat areas towards the interior of the filter preferably corresponds to the rib-shaped structure of the filter walls in the face-end area of the flat area. In the case of filter walls with a zigzag structure with backs running in the direction of flow, the flat area is thus likewise preferably of zigzag design, the same applying in the case of wave-like structuring of the filter walls, where the flat areas preferably extend into the interior of the filter in wave-like fashion. In the apex area of the filter wall ribs, the flat areas each preferably display a deeper extension into the interior of the filter, preferably a maximum extension, where, in the area of structure valleys, such as the valleys of waves or the depressions of ribs, the flat areas display a smaller, preferably a minimal, distance from the face end of the filter. The flat areas and the filter wall structures preferably essentially correspond to each other in terms of dimensions, for instance with tolerances of less than 20%, preferably less than 10%, or particularly preferably essentially without any deviation. In this context, the flat areas transition, preferably in more or less step-like fashion, particularly preferably with an essentially right-angled step profile, where the deflection edges can be of arc-shaped design, where appropriate, into the filter wall areas in which adjacent filter walls are distance apart from each other. The vertical structuring of the filter walls thus preferably corresponds to the structuring of the flat areas in the direction of flow through the filter. This makes it possible to provide flat areas or double layers on the inflow and/or outflow side of the filter, which stabilize the filter at the face end and result in more favorable flow conditions, essentially solely by deformation of the filter walls, without material compression or material elongation occurring.

Further, the filter walls can display kink areas or deflection areas for the fluid within the filter, producing a vertical offset relative to filter wall areas upstream and downstream of the kinks, this permitting deflection of the direction of flow within the filter. As a result, the filter can be better adapted to the respective structural conditions and/or the flow deflectors can create favorable flow conditions in the area of the kinks.

The filter walls can, in particular, be structured to form wave crests and wave valleys in such a way that their apex lines are alternately inclined relative to each other in the direction of flow, meaning that the apex lines of adjacent apexes of a filter wall intersect in a lateral projection. As a result, the filter wall profiles that widen and narrow in the direction of flow bring about a crosswise offset of the fluid flowing through. It goes without saying that the corrugations can be of essentially arc-shaped or essentially zigzag design, where ribs of different heights can also be produced by the corrugations, where appropriate.

Alternatively, or in combination with this, the deflection areas of the filter material strip can, on the inflow side and/or the outflow side, display a height transverse to the direction of flow through the filter, such that adjacent filter walls are spaced apart from each other at the face end by the deflection areas. In particular, this spacing can be accomplished, e.g. by means of web-like deflection areas, in such a way that the spacing on the inflow side and the outflow side is different. The inflow side can, for example, thus display a greater area than the outflow side of the filter. Independently of this, as a result of this measure, the flow ducts or flow slits for the fluid medium, formed between adjacent filter walls, can become narrower or, where appropriate, wider towards the outflow side. Further, particle filters of trapezoidal, rhombic or other form can be produced in this way.

According to another advantageous embodiment, the filter material strip deposited in meandering fashion, which can, in particular, also be folded in the form of a double layer along a folding line running in the longitudinal direction of the strip, can be folded or rolled up around a filter body longitudinal axis, meaning that essentially cylindrical filters, or filters with semicircular segments, can be manufactured.

Preferably, the particle filter is provided with stiffening elements that stabilize the filter walls, e.g. by supporting or penetrating the filter walls and being connected to them in force-transmitting fashion.

Elongated stiffening elements are preferably provided, which are located between adjacent filter walls, penetrate the filter walls and/or are located on the face end of the filter, and act on the filter walls and/or the deflection areas connecting them. The stiffening elements can, for example, be designed in the form of wires or strips, structured strips, such as strips deposited in zigzag or wave-like fashion, layers of expanded metal or the like. The stiffening elements can simply be arranged in the form of spacers between adjacent filter walls, propping them against each other, although the stiffening elements can alternatively or additionally also be connected in tensile force-absorbing fashion to the side walls of the filter or a filter housing provided, where the stiffening elements are fixed in place in tensile force-absorbing fashion at one or, preferably, both ends. The stiffening elements can be fixed in place by non-positive and/or positive means, such as by folds of the filter material strip, including lateral areas of different material fastened to them, such as sheet metal-like strips or the like. Where appropriate, the stiffening elements can also be materially connected to an area of the particle filter, such as the side walls, e.g. by means of welding. The stiffening elements can be provided only in some areas of the filter, although each filter wall is preferably stabilized by at least one, preferably two, three or more stiffening elements. In particular, the stiffening elements can also be located on the face end on the inflow and/or outflow side of the filter, e.g. inserted in face-end indentations of the deflection areas of the filter material strip. In each case, the stiffening elements preferably extend continuously over the extension of the particle filter in the respective direction, e.g. over the full length, height or width, or a plane or body diagonal of the filter.

Preferably, elongated stiffening elements are provided, e.g. in the form of wires or strips, at the level of the flat areas of pairs of adjacent filter walls spaced apart over some areas, which can form double layers, in particular. In this context, the stiffening elements preferably extend perpendicularly to the direction of flow through the filter, particularly preferably at the level of the face end of the filter on the inflow and/or outflow side. This makes it possible to stabilize the face ends of the filter, in particular.

Independently of the other design aspects of the stiffening elements, they are preferably electrically insulated in relation to the filter walls stiffened by them, particularly in order to avoid short-circuits between filter walls in the case of an electrically heated particle filter, this occurring, for example, when the filter is to be heated for regeneration when sufficient soot has accumulated. Electrical insulation of this kind can, for example, be achieved by the stiffening elements displaying an electrically non-conductive sheath, e.g. of ceramic material or due to formation of an oxide layer. Where appropriate, electrical insulation can also be provided only in certain areas.

Where appropriate, several stiffening elements can be connected to each other, preferably in tensile force-absorbing fashion, e.g. layer-by-layer, forming two or three-dimensional systems of stiffening elements. In particular, the stiffening elements can be designed in the form of one or two-dimensional layers of expanded metal, or areas thereof.

It goes without saying that, where appropriate, the stiffening elements can also be deposited by weaving into the structure of the filter material strip deposited in meandering fashion, where the directions of longitudinal extension of the stiffening elements and of the filter material strip can cross each other, and are preferably arranged perpendicularly to each other.

Preferably, at least one stiffening element is provided, or also several, where appropriate, that extends around the full circumference of the filter and runs transverse to the direction of extension of the filter walls. In this context, the stiffening element can span the inflow and outflow sides of the filter, or alternatively or, where appropriate, simultaneously the two opposite side walls of the filter. In particular, the stiffening element can also be wound around the filter in such a way that, in the manner of a helical structure, several windings with a specific pitch are provided, as a result of which the particle filter can be stabilized by a continuous stiffening element over a relatively large lateral extension in relation to the longitudinal direction of the stiffening element, or over its full extension transverse to the stiffening element. The pitch of the stiffening element preferably corresponds to the spacing of longitudinal structures of the filter walls, such as a rib spacing or wave spacing of the same. In this way, one or, preferably, two stiffening elements can, for example, stabilize the entire filter in the manner of a coherent package. The end areas of the stiffening element are preferably fixed in place on the filter or the housing in tensile force-absorbing fashion, e.g. on a different area of the same stiffening element, or they are connected on a side wall of the filter or a filter wall in tensile force-absorbing fashion, e.g. by clamping.

Further, structural elements with catalytically active material are provided, preferably between the filter walls or on the face end of the filter. Structural elements of this kind can, in particular, be the stiffening elements described above, or separate, additional components, without being limited to this. The catalytically active structural elements can be connected to the filter walls, the side walls of the filter and/or an envisaged filter housing in tensile force-absorbing fashion. In particular, the catalytically active structural elements can be fixed in place between adjacent filter walls in positive and/or non-positive fashion, e.g. by clamping, folded seams or the like. The catalytic activity can relate to the conversion of a component of the fluid medium, e.g. to cleaning of the fluid medium, such as the decomposition of nitrous oxides into nitrogen and oxygen, to the oxidation of components of the fluid medium, or to oxidative conversion of the particles to be separated.

The particle filter preferably displays at least one or more inflow sides, which permit inflow of the fluid medium into the particle filter from different directions, the fluid medium entering ducts for the fluid medium formed between adjacent filter walls, where at least one outflow side is provided, through which the fluid medium emerges from the particle filter in a direction that differs from at least one inflow direction. As “elbow ducts”, the ducts can permit a change of direction of the fluid flowing through. Particle filters of this kind can, in particular, also be used as manifolds. The two different inflow directions can, for example, each enclose an angle of 90° or 180°, without being limited to this. Where appropriate, the fluid medium can enter the particle filter from two or from three inflow sides and emerge from the particle filter on a fourth side. In this context, the particle filter can, in particular, display an essentially cubic or trapezoidal shape, without being limited to this. The outflow direction can enclose an angle of approx. 60° to approx. 120°, particularly of approx. 90°, with the inflow direction of one or two inflow sides of the filter, where the outflow side can, where appropriate, be arranged in essentially the same direction as an inflow direction from a third side. It goes without saying that, where appropriate, one or two of the inflow sides mentioned can also be sealed. Thus, generally speaking, the inflow direction of the fluid medium into the particle filter can enclose an angle relative to the outflow direction, particularly an angle of 90°. The inflow area can in each case extend over part of the side surface of the filter, particularly over the full height of the filter in the stacking direction of the filter walls, or over essentially the full side surface.

An example of the invention is described below and explained on the basis of the Figures. The drawings show the following:

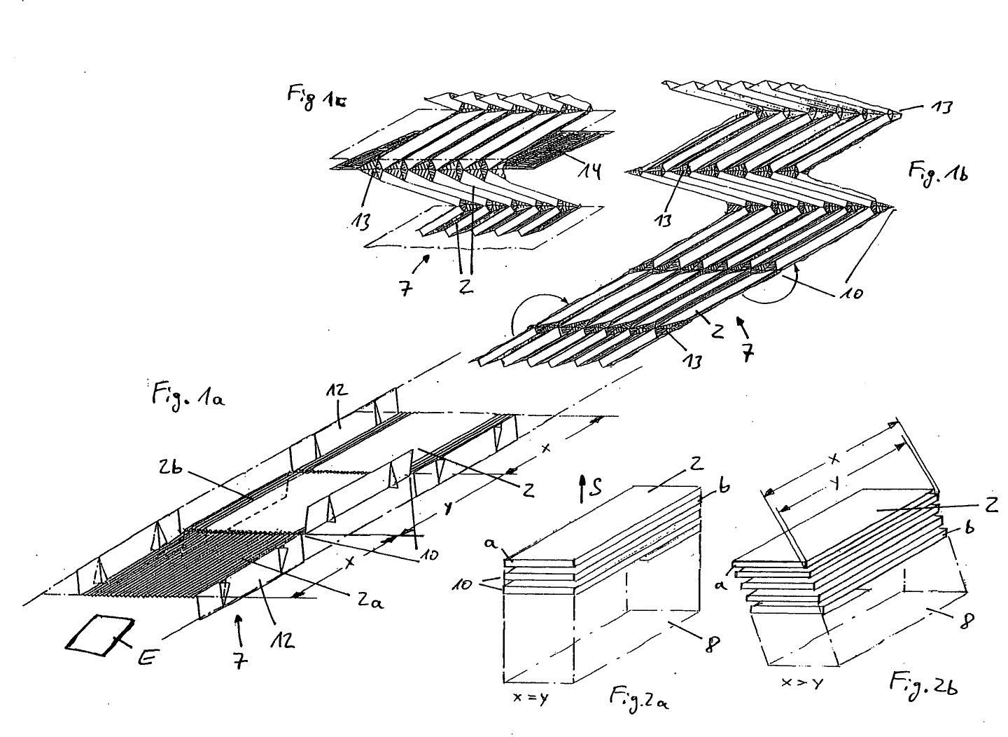

FIGS. 1a-c: a profiled strip of filter material for manufacturing a particle filter, in various folded states,

FIGS. 2a, b: schematic representations of a particle filter made of filter material strip deposited in meandering fashion,

FIG. 3: a production line for manufacturing a particle filter from filter material strip with separate, inserted layers,

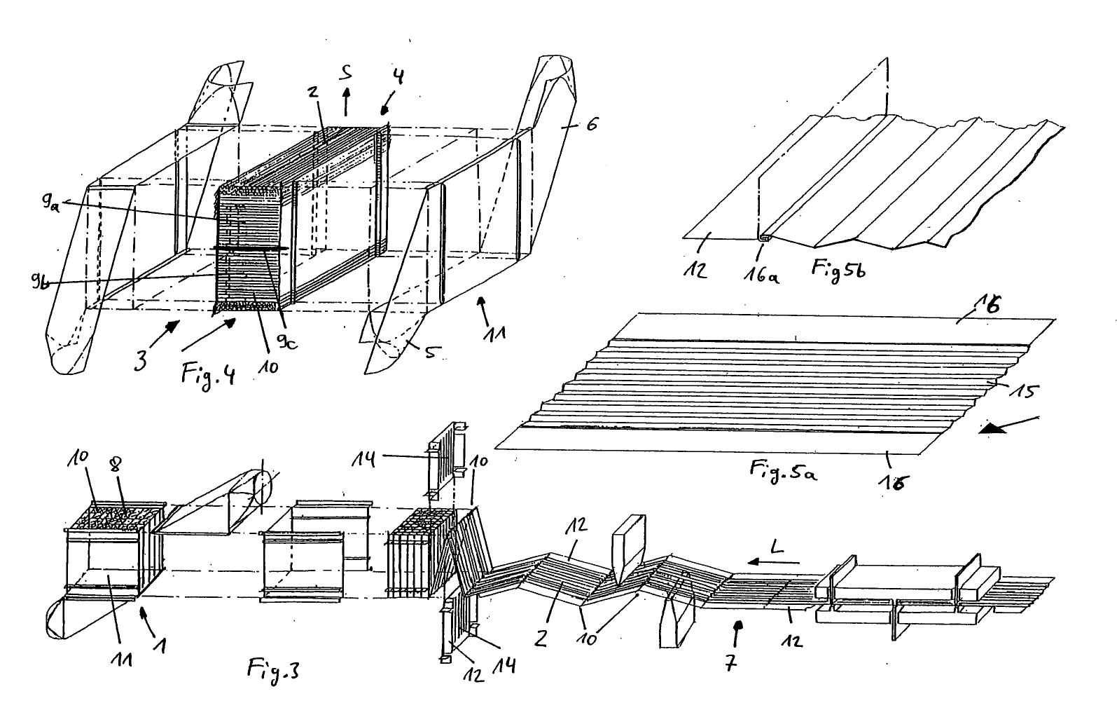

FIG. 4: a schematic representation of a particle filter with inflow and outflow nozzles,

FIGS. 5a, b: perspective representations of a filter material strip,

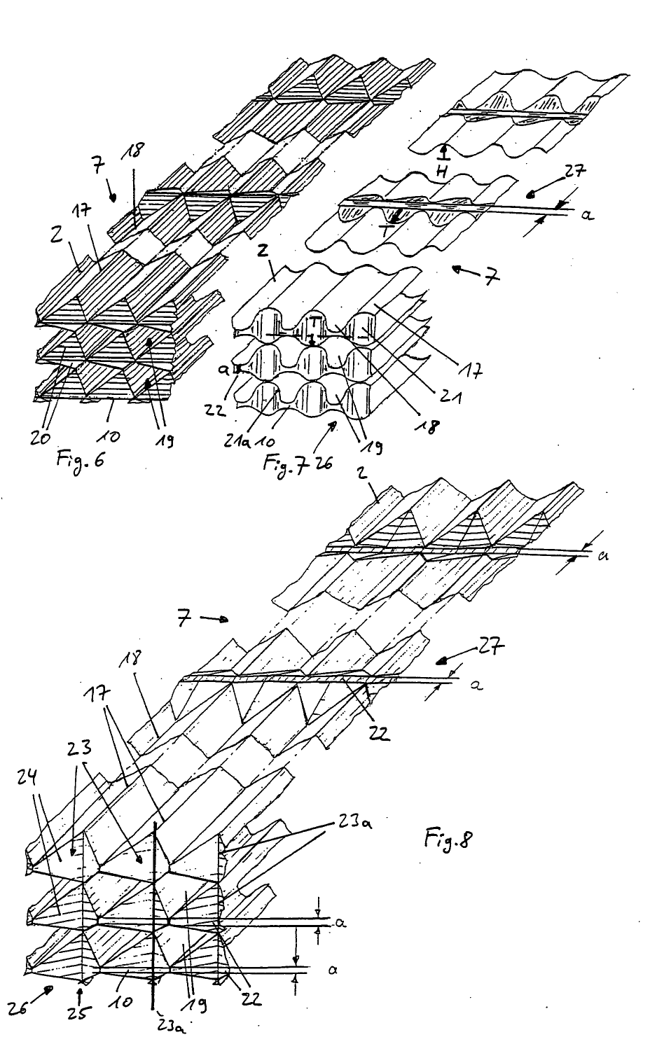

FIG. 6: a perspective representation of a section of a partly manufactured particle filter,

FIG. 7: a perspective representation of a section of a partly manufactured particle filter,

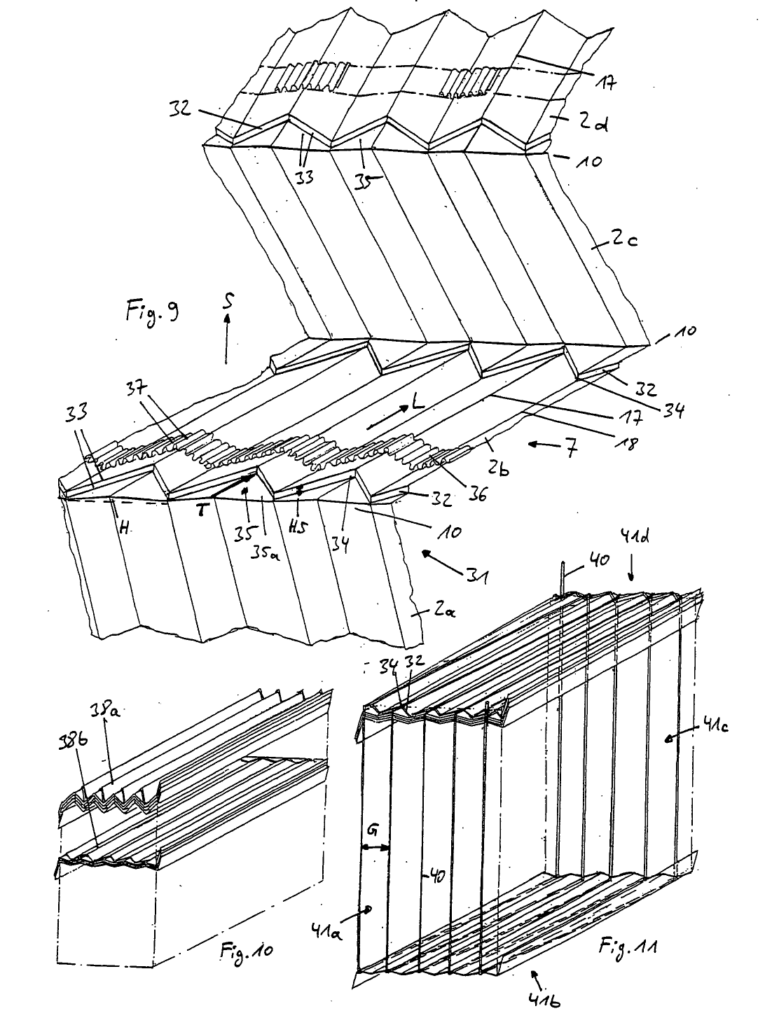

FIG. 8: a modification of a particle filter according to FIG. 6,

FIG. 9: a perspective partial section of a partly folded filter material strip for manufacturing a particle filter,

FIG. 10: a schematic representation of a particle filter with differently structured filter walls,

FIG. 11: a schematic, perspective representation of a particle filter with stiffening element,

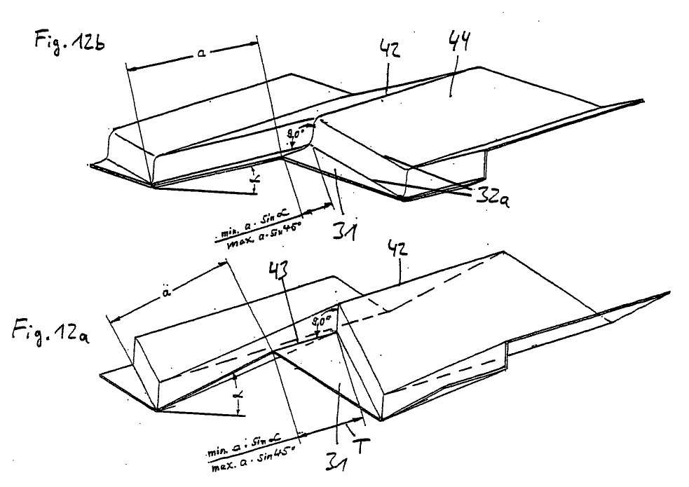

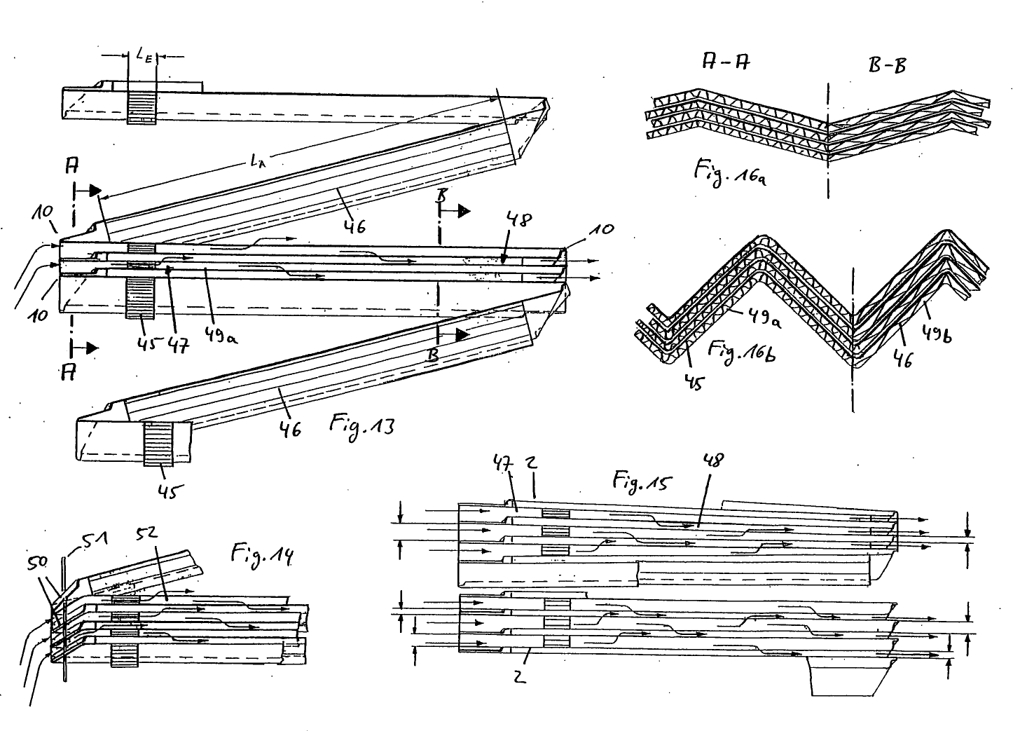

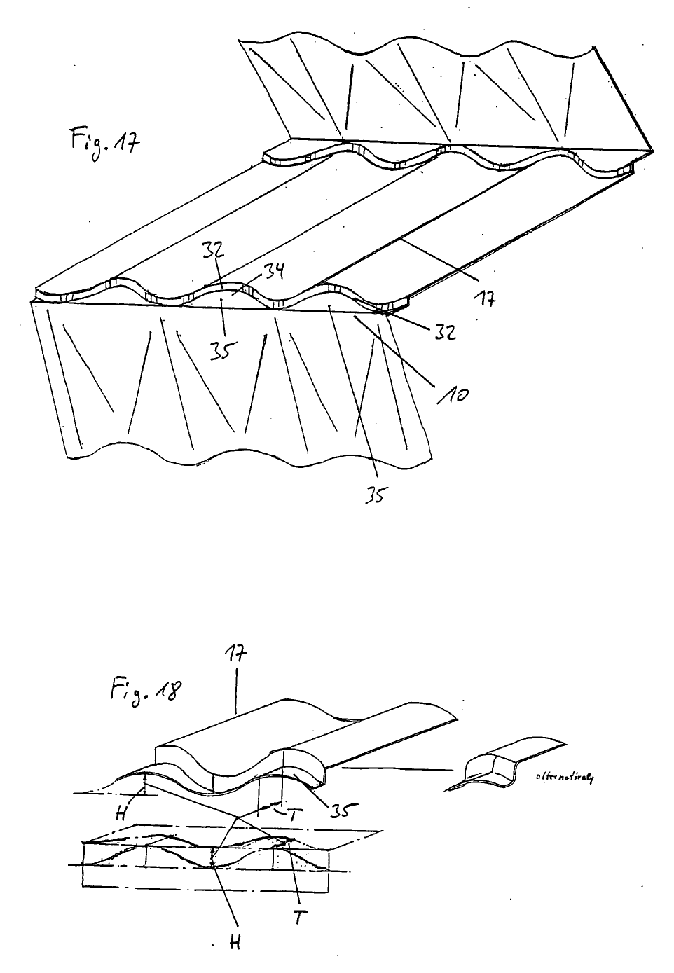

FIGS. 12a, b: detail representations of a section of the filter material strip according to FIG. 9,

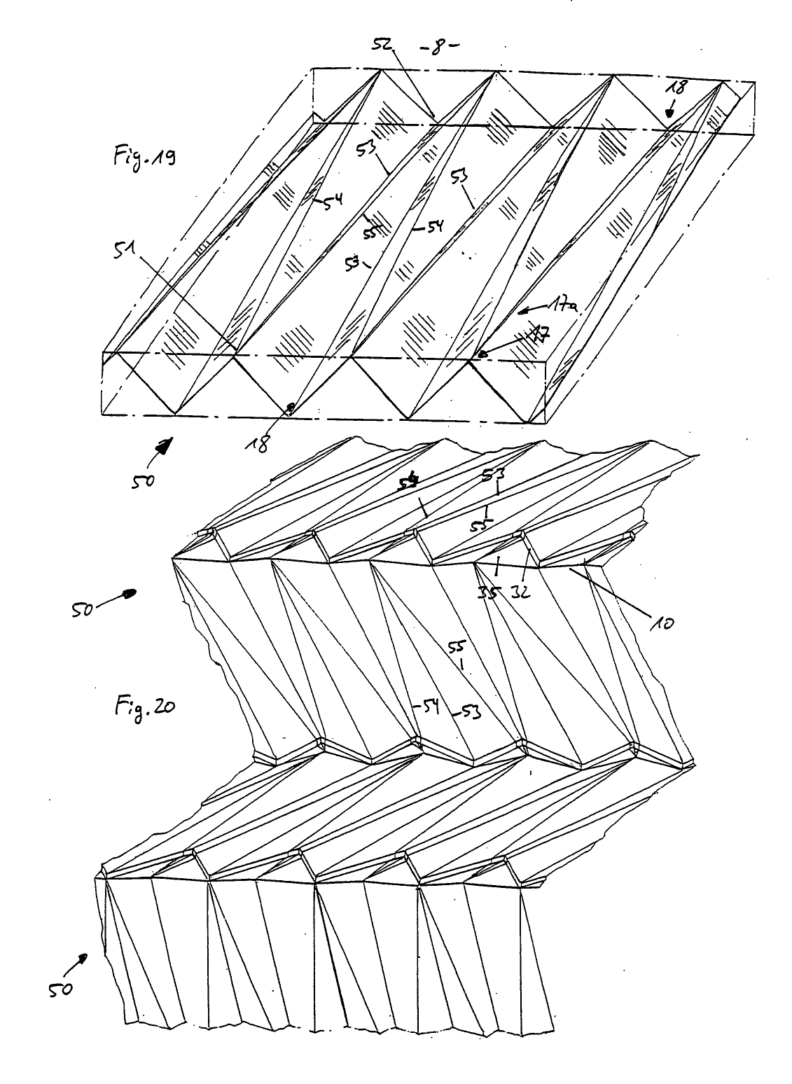

FIG. 13: a schematic representation of a partly folded filter material strip for manufacturing a particle filter,

FIG. 14: a modification of a filter material strip according to FIG. 13,

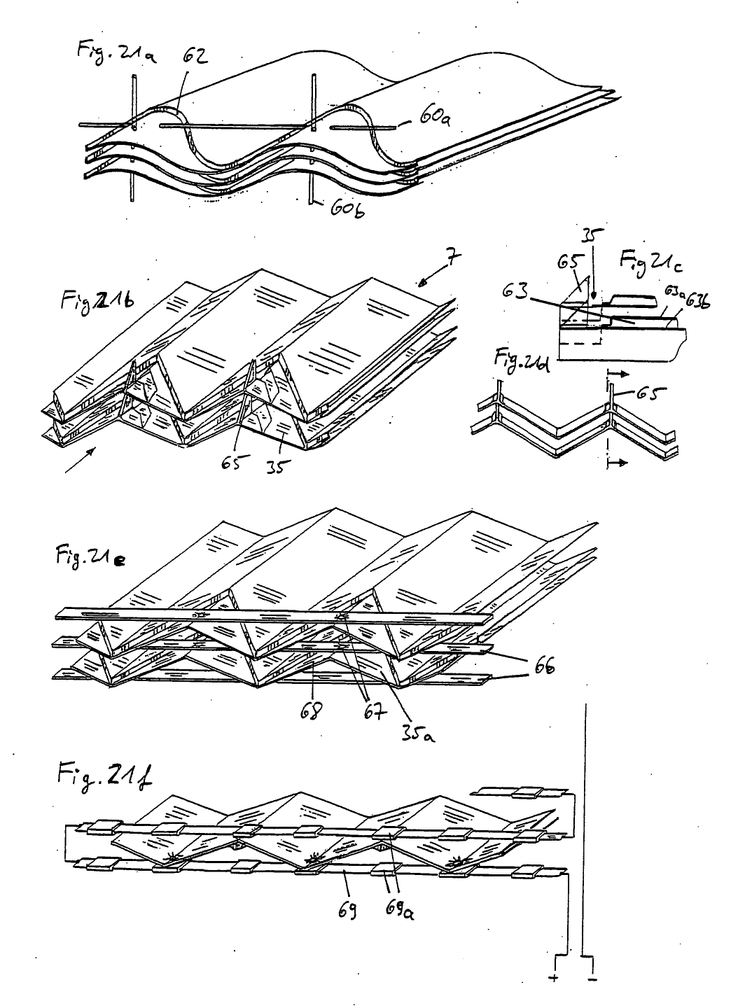

FIG. 15: a modification of a filter material strip according to FIG. 13,

FIGS. 16a, b: sectional representations along lines A-A and B-B of the filter material strip according to FIG. 13 in various folded states,

FIG. 17: a partly folded filter material strip for manufacturing a particle filter,

FIG. 18: a detail view of the filter strip according to FIG. 17,

FIG. 19: a perspective view of a section of a filter material strip for manufacturing a particle filter,

FIG. 20: a perspective view of a partly folded filter material strip for manufacturing a particle filter,

FIGS. 21a-f: perspective representations of sections of filter material strips for manufacturing particle filters,

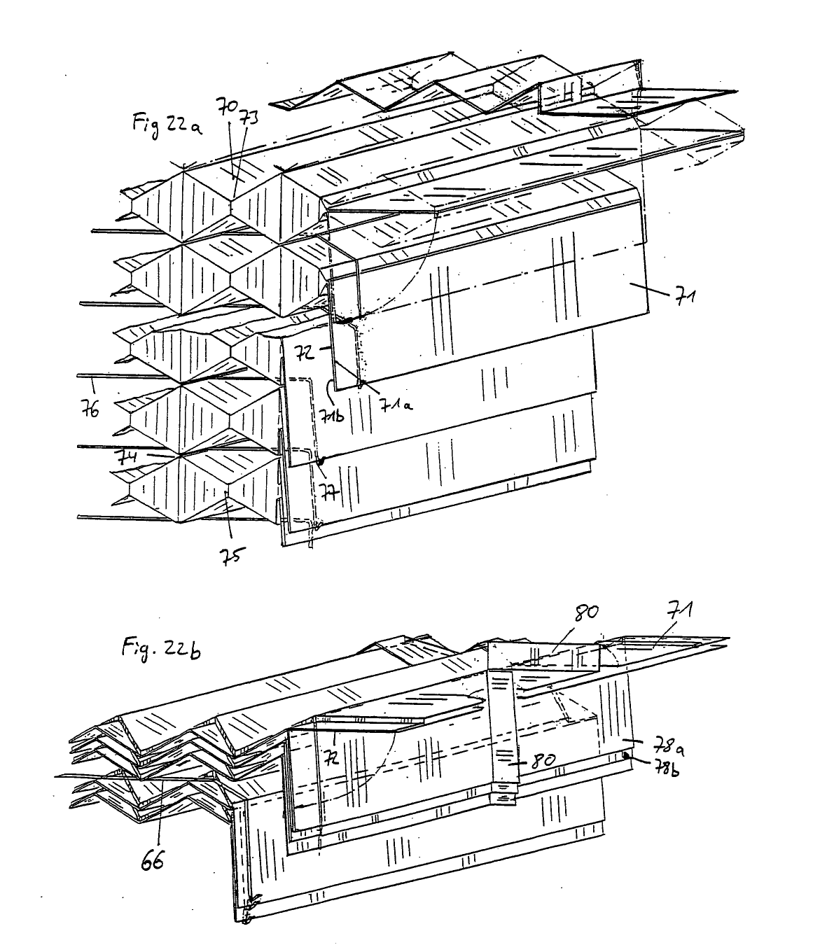

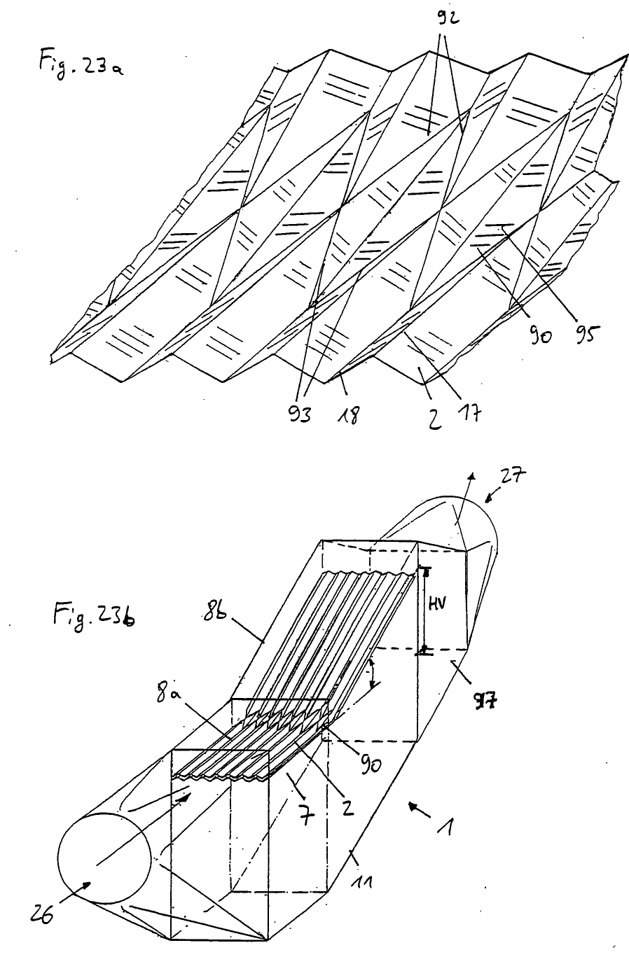

FIGS. 22a-c: perspective views of sections of particle filters with side walls,

FIGS. 23 a, b: perspective views of a section of a filter material strip for manufacturing a particle filter, and of a filter material strip according to FIG. 23a, arranged in a housing,

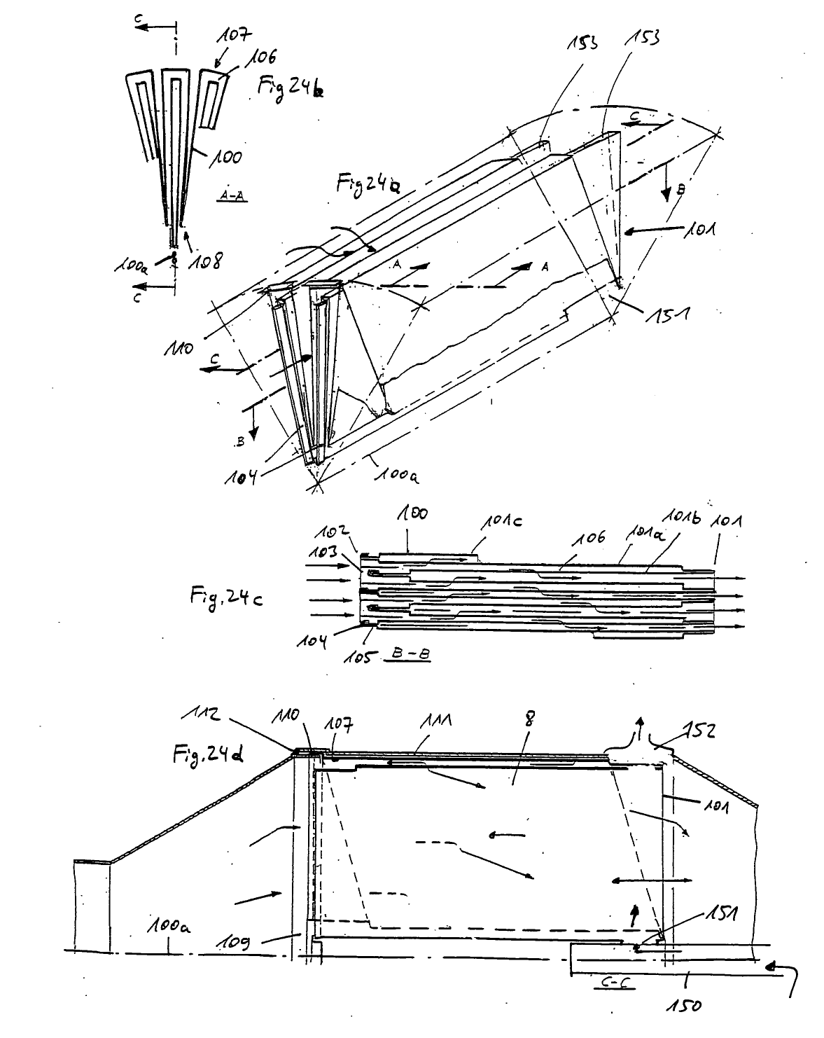

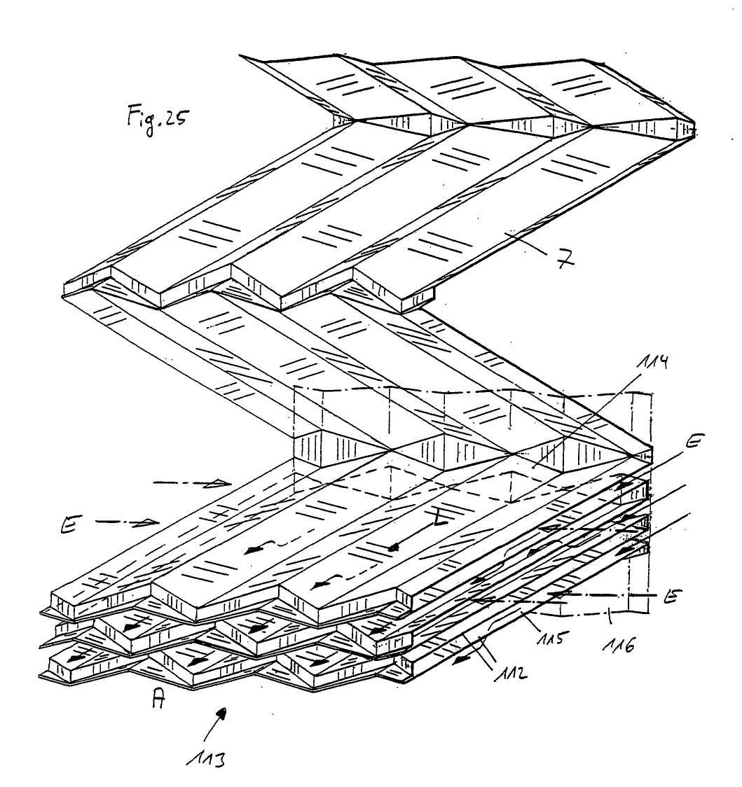

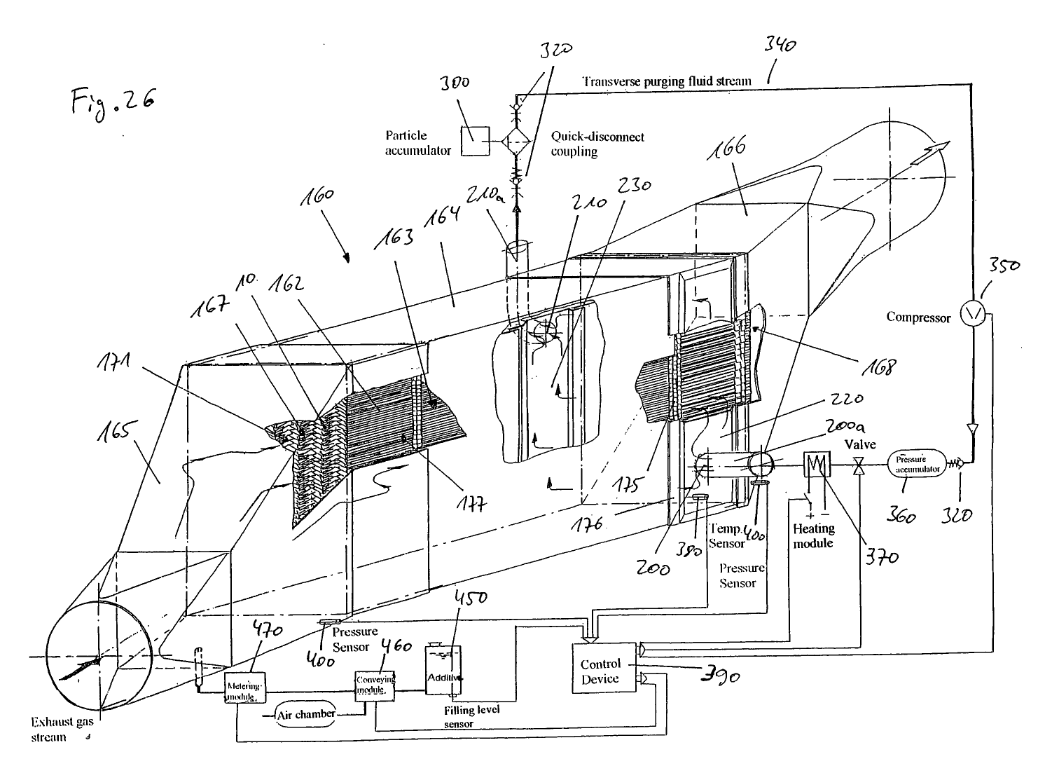

FIGS. 24a-d: perspective views and sectional representations of sections of a particle filter,

FIG. 25: perspective representations of a partly folded filter material strip for manufacturing a particle filter with different inflow directions.

FIGS. 1 to 3 show the manufacture of a particle filter according to the invention, which can be used as a soot filter for diesel-fuelled internal-combustion engines, for example. Particle filter 1 displays a plurality of filter walls 2 to be flowed through, which can consist of a structure-forming fabric, such as wire mesh, which is provided with a ceramic coating in order to be permeable to the fluid, e.g. a gaseous fluid, and to be able to filter out particles entrained by said fluid, at least upwards of a specific particle size. It goes without saying that the usual devices provided for regenerating particle filters, such as heating devices, can be provided. In this context, the particle filter displays an inflow side 3 and an outflow side 4, where, as illustrated in FIG. 4 by inflow nozzles 5 and outflow nozzles 6, which can be components of an associated housing, the direction of inflow (arrow) can also be inclined relative to the principal plane of filter walls 2 and to the direction of flow of the fluid medium through the filter (arrow; FIG. 4). According to the invention, the filter walls consist of a continuous strip 7 of filter material, which can be provided with structures by means of suitable profiling means, such as embossing rolls, forming rib-like structures preferably running essentially in the longitudinal direction of the strip (arrow; FIG. 3). At least in the area of filter walls having a filter effect, the continuous strip is preferably designed in one piece in a length suitable for manufacturing a filter body 8, which forms the particle filter at least in one dimension, although several filter bodies can also be arranged alongside or above and/or behind each other. As indicated in FIG. 4, several filter segments 9a, 9b, each with a plurality of filter walls 2, can also be provided, where appropriate, where the ends of the strips creating the filter segments can be connected together, e.g. by a folded seam connection or a welded connection, or where the strip ends of adjacent filter segments are connected to an at least essentially particle-tight retaining element, such as a clamping or retaining rail 9c, where the retaining rail can be immovable, or sufficiently stabilized in its target position by fastening means, but still capable of slight movement, e.g. fixed in place on the housing.

To manufacture the particle filter, the filter material strip is deflected in deflection areas 10 and, in this process, deposited, preferably in meandering fashion, with deflection of at least approximately 180°, such that the areas of the filter strip deposited in stacking direction S (FIGS. 2a, 4), which form filter walls 2, are folded to form a filter, or at least a segment thereof. As a result of the deflection areas, which extend over more than half of the extension of the filter, e.g. over one direction of extension of the filter or, forming side wall areas, beyond this, a filter is created with little manufacturing effort that is sufficiently stable and reliably tight even when exposed to stresses, such as dynamic forces, varying temperatures or the like.

The strip deposited to form deflection areas 10, which is preferably deposited in meandering fashion (FIGS. 1-3), can be folded and accommodated in a housing 11 in such a way that the deflection areas are located on the inflow side and/or the outflow side.

Deflection areas 10 are areas of the strip, integrated in said strip in one piece, which preferably extend over the full width of the strip having a filter effect, or over the total width of the strip. The complete array of the filter walls of particle filter 9 can thus consist of one continuous strip of filter material. Where appropriate, however, several filter material strips can be connected to each other along joining lines running essentially in the longitudinal direction of the strip, thereby broadening the strip, e.g. by adjacent strips being welded or folded together in their lateral edge areas. In this case, the deflection areas then preferably extend over the width of the respective part strips having a filter effect, or the total width of the respective part strip.

According to FIG. 1a, the filter material strip can be provided with lateral areas 12, which are bent over relative to principal plane E of the filter walls, preferably by approx. 90°, and which can be connected to each other, forming lateral stabilization areas of the filter body, or forming as essentially closed and particle-tight side wall. The lateral areas are preferably folded over in opposite directions on adjacent filter walls (FIG. 1a). The side areas can consist of filter material or, pursuant to FIG. 5, another material.

Adjacent filter walls 2a, 2b, which consist of adjacent sections of the filter material strip separated by deflection areas 10, can display the same extension in the longitudinal direction of the strip (X=Y), such that an essentially cubic filter body is obtained (FIGS. 1a, 2a), although the lengths of the filter walls in the longitudinal direction of the strip can, where appropriate, also be different (X>Y), such that an oblique, e.g. trapezoidal, filter body results (FIG. 2b). It goes without saying that, in both embodiments according to FIGS. 2a, 2b, the face-end deflection areas can display identical heights a, b on the inflow and outflow side, or different heights.

According to FIG. 1b, strip 7 is profiled in such a way that, after the strip has been folded together to form the deflection areas according to FIG. 1c, adjacent filter walls 2a, 2b, which form a double layer of the strip, are structured inversely relative to each other, i.e. their crests and valleys face each other. To permit folding of the structured strip, deflection areas 10 are provided with indentations 13, such that, owing to the extensive lack of ductility, deflection of the strip sections with the given profiling of the strip can be performed essentially or completely without compression or elongation of the filter material, but by deformation by deflecting strip sections.

According to FIG. 1c and FIG. 3, layers 14, which can essentially have the extension of the filter walls about their principal plane, can be inserted between respectively adjacent filter walls 2a, 2b, which are connected by a deflection area 10, where layers 14 can, for example, be provided with a catalytically active material capable of catalyzing chemical conversions of the fluid medium, such as can be advantageous for the purification of exhaust gases. The layers can, in particular, be permeable to the fluid and designed as grid-like structures, wire mesh, layers of expanded metal, fleece layers or the like. The layers can also be of strip-like design and extend over only part of the width or part of the length of the filter. According to FIG. 3, separately inserted layers 14 can have lateral areas 12, which are bent over relative to their principal planes, in order to construct a side wall of a filter or to stabilize the filter body consisting of the filter walls, and can be provided as an alternative or in addition to lateral areas 12 of the strip.

According to FIG. 5a, the strip producing a plurality of filter walls comprises a central section 15, which consists entirely of filter material, and longitudinal strips 16 attached to it on both sides, which are connected to the lateral edge area of the central strip, e.g. by a welded connection or by a folded seam connection 16a, an example of which is illustrated in FIG. 5b. Longitudinal strips 16 can consist of a fluid-impermeable sheet-metal material, such that fluid-tight side walls of the filter can be constructed in a simple and inexpensive manner. It goes without saying that, independently of this, the filter walls preferably consist of filter material over their entire superficial extent, insofar as this is located in an area of the particle filter that has a filter effect and is accessible to the fluid to be cleaned. Thus, the strip of filter material can be a uniform fabric over its full length and width.

FIG. 6 shows a section of a filter material strip 7 for producing a particle filter that has been deposited in meandering fashion, where adjacent filter walls 2, which are connected to each other by deflection areas 10 extending over the width of the strip, are structured inversely relative to each other. In this case, the structure is produced by essentially zigzag-shaped corrugations, forming angular crests 17 and angular valleys 18. The crests of adjacent filter walls are preferably in linear contact with each other over their full length, the inverse arrangement of the valleys forming essentially one-dimensional flow ducts 19 for the fluid medium, where the fluid medium, passing through the filter walls, can flow out of the filter on the opposite side via one-dimensional flow ducts. In this case, deflection areas 10 are of essentially angular design, where surfaces 20 are formed on them, receding towards the interior of the filter and set at an angle against the longitudinal direction of flow ducts 19. The inclination and extension of surfaces 20 are selected in such a way that the strip is deposited in meandering fashion virtually without elongation or compression, but only by formation of the deflection and kink areas shown, preserving the profiling. In this context, the peaks of triangular surfaces 20 point in the longitudinal direction of flow ducts 19.

FIG. 7 shows a strip with inversely profiled filter walls 2, deposited in meandering fashion, similarly to that in FIG. 6, where profiling is, however, performed in the form of corrugation forming arc-shaped crests 17 and valleys 18, where crests 17 are again in linear contact with each other, forming one-dimensional flow ducts 19. In this context, deflection areas 10 are formed by creating wave-like indentations 21, where the cross-sectional profile of crests 17 essentially or exactly corresponds to the profile of indentations 21 at the level of deflection areas 10 in a direction parallel to the filter walls, in order to allow deflection of the profiled strip with little elongation and compression. The deflection areas according to FIG. 7 display web-like areas 22 with a constant web height a over the width of the strip, where web height a can be identical or different on the inflow side and the outflow side in order to vary the geometry of the filter body. The same is also possible according to FIG. 6.

Depth T of indentation 21 parallel to the longitudinal direction of flow ducts 19 or the longitudinal direction of the crests, is thus essentially equal to the height H of crests 17 exceeding web a. The front side of indentation 21 thus runs essentially perpendicularly to the longitudinal extension of crests 17 or the longitudinal direction of flow ducts 19. It goes without saying that, where appropriate, the essentially angular border of indentations 21, formed by boundary edges 21a, can also be of flattened or arc-shaped design.

FIG. 8 shows a further possibility for profiling the filter material strip, forming inversely structured, adjacent filter walls, where deflection areas 10 can again display webs 22 with a height a. In contrast to FIG. 6, indentations 23 are formed here, in order to again permit deflection of a profiled strip with virtually no elongation and compression, where end area 23a of the indentation, pointing towards the interior of the filter, is of essentially linear, preferably straight, design and runs essentially or exactly perpendicularly to the extension of deflection area 10 and/or the longitudinal extension of the ribs, designed as crests 17. The essentially plane surfaces 24 of the indentations thus display common edges, located in the interior of the filter, in contrast to which, according to FIG. 6, the common edge of adjacent surfaces 20 of adjacent filter walls is located on the face end. According to FIG. 8, indentations 23 of adjacent pairs of filter walls can thus form continuous indentation lines 25, which extend transversely, particularly perpendicularly, to the principal planes of the filter walls. These indentations stabilize the face ends, which can particularly constitute inflow and outflow sides of the filter. Stiffening elements 23a, described further below, can be inserted into linear indentations 23 and are protected by the indentations against lateral displacement, e.g. in the manner of stiffening element 40 according to FIG. 11. It goes without saying that indentations 23 are not limited to the design shown, but that the edges bordering surfaces 24 can, where appropriate, also be of kinked or arc-shaped design, as a result of which the deflection areas of the strip can be structured in a variety of ways.

Further, it also goes without saying from FIGS. 7 and 8, and this can also apply accordingly to other embodiments of the filter according to the invention, that the web heights a on inflow side 26 and outflow side 27 can be different, where on the inflow side, for example, the crests of adjacent filter walls, which are assigned to different double layers, can make essentially punctiform or linear contact with each other over an extension that is essentially smaller than the length of flow ducts 19, e.g. one-tenth of less thereof, where the crests of adjacent, inversely structured filter walls can be an increasing distance apart with increasing depth of extension into the filter, such that the essentially one-dimensional flow ducts on inflow side 26 expand into essentially slit-like flow ducts on outflow side 27, which can extend, transversely to the direction of flow, over several flow ducts or the full strip width or filter width.

According to FIGS. 1 to 8, the strip of filter material, deposited in meandering fashion, is deposited in such a way that longitudinal direction L of the strip (arrow; FIG. 3) runs essentially parallel to the direction of flow of the fluid medium or the direction of extension of essentially one-dimensional flow ducts 19 pursuant to FIGS. 6 to 8. It goes without saying that, where appropriate, strip 7 pursuant to FIG. 3 can also be folded along a folding line, forming at least a double layer, and that the strip doubled in this way is deposited in meandering fashion, as illustrated in FIG. 3 for the single-layer strip. In this context, the deflection areas can be continued towards the outside and folded over to allow the doubled strip to be deposited in meandering fashion. As a result, particle filters can be manufactured, in which the direction of flow against the filter is transverse or perpendicular to the longitudinal direction of the strip, meaning that, for example, the folding line represents a leading edge for the fluid medium, and deflection areas 10 of the strip are located on the side walls of the filter.

FIG. 9 shows a strip 7 of filter material, deposited in meandering fashion, with profiles designed as ribs in the form of crests 17 and valleys 18 located between them, which extend essentially in the longitudinal direction L of the strip or the direction of flow, where, according to the practical example, the profiling is essentially of zigzag design. According to the practical example, adjacent filter walls are structured congruently relative to each other, i.e. with crests and valleys that engage each other. Viewing a given side of the particle filter, such as inflow side 31 according to FIG. 9, adjacent filter walls 2a, 2b; 2c, 2d, which are immediately connected to each other by a deflection area 10 assigned to this side, form a double layer, meaning that filter walls 2a, 2b are assigned to a first double layer, and filter walls 2b, 2c to a second double layer. In this context, at least one filter wall of each double layer is provided with a step 32 or a shoulder, where the shoulder can display essentially rectangular or also arc-shaped deflection edges 33 (cf. also FIG. 12b). According to the practical example, one filter wall 2b, 2d in each case is provided with two such steps 32, where both steps rise in the direction of flow through the filter or in the longitudinal direction of the ribs designed in the form of crests 17, meaning that the vertical offset of the steps adds up over the direction of extension of the respective filter wall. In this context, the steps extend in essentially wave-like fashion into the interior of the filter, starting from an area facing deflection area 10, meaning that, according to the practical example, steps 32 run in essentially zigzag fashion in the plane of the filter wall. If the ribs are designed more like waves, with arc-shaped crests and valleys, the steps preferably like-wise run essentially in arc-like corrugations with a direction of extension in the direction of flow or the longitudinal direction of crests 17 (see also FIGS. 17, 18). Referred to stacking direction S (arrow), the areas of steps 32 facing the filter wall or the inflow side are located in the valleys, and the areas 34 of the steps that are the greatest distance away from deflection areas 10, and on which the corrugation of the steps reverses, are located at the level of crests 17. The height of the filter wall corrugations and the height of steps 32 thus add up. The face-end areas of steps 32 are located roughly at the level of deflection areas 10, and it goes without saying that they can, where appropriate, also be separated from the particle filter wall or the face end by a web-like area. Depth T of indentations 35 formed by the steps, which expand towards the face end of the filter or deflection areas 10, is in this instance a multiple of height H of the ribs or crests 17. At the same time, or independently thereof, height HS of steps 32 in stacking direction S can be essentially or exactly equal to height H of the rib-like structures of the filter walls running in the direction of flow.

According to the practical example, the respectively opposite filter walls of a double layer, i.e. filter walls 2a, 2c, which are assigned to filter walls 2b, 2d, are not provided with a step, but merely with a longitudinal profile corresponding to the profile of stepped filter walls 2b, 2d that produces the crests and valleys. Thus, at the level of indentations 35, the filter walls of the first group, i.e. filter walls 2a, 2c, are in contact with filter walls 2b, 2d of the second group, preferably over relatively large areas in each case, particularly in plane fashion over the extension of the indentations, as a result of which flat areas 35a of the filter pockets are formed. This results in additional stabilization of the filter walls in the area of the deflection areas, which can particularly constitute the inflow and outflow areas of the filter, while moreover creating favorable flow conditions for inflow of the fluid medium.

Steps 32 thus create filter pockets by means of opposite filter walls a distance apart from each other. In this context, the filter pockets are alternately open towards the inflow side and towards the outflow side of the filter. Where appropriate, the pockets can also display a greater width in stacking direction S than the height of steps 32, to which end adjacent filter walls can be inclined relative to each other or relative to the longitudinal direction of the filter.

According to the practical example, the filter walls of one group are in each case provided with two steps 32. Where appropriate, further, intermediately located steps can also be provided on the walls of the group mentioned, and/or filter walls of the second group, filter walls 2a, 2c in the practical example, can be provided with steps, where the steps of the two groups of filter walls can add up, expanding the filter pockets formed by the filter walls, or also cancel each other out, where appropriate.

If filter pockets are formed between adjacent filter walls, as in an embodiment according to FIG. 9, for example, where the filter pockets form slits extending over partial areas or the full width of the filter, stiffening elements 36, extending transversely to the direction of flow, can be provided in these slits, separating adjacent filter walls from each other. According to the practical example, stiffening element 36 is designed in the form of a corrugated strip, where the individual crests 37 form supports for the filter walls. In this context, stiffening element 36 can be coated with a catalytically active material or, where appropriate, designed as a heating element. The stiffening element can extend essentially over the width of the filter, or it can transition into the side walls of the filter and be fastened to them or fixed in place on the filter in some other manner.

According to FIG. 10 and as schematically illustrated, rib-like longitudinal profiles 38a, 38b of the strip, which can be realized in various filters, can display a different inclination or width, as a result of which the flow resistance of the fluid medium transverse to the direction of flow (arrow) can be varied.

According to FIG. 11, a one-dimensional stiffening element 40 is provided in the form of a wire or, where appropriate, also a strip or the like, which is wound in helical fashion around filter 41 and, in this context, encompasses inflow side 41a, underside 41b, outflow side 41c and top side 41d of the filter. In this context, the stiffening element is wound around the filter in several pitches G and thus extends over several rib-like longitudinal profiles or crests of the strip. In the winding arrangement shown, the stiffening element preferably extends continuously over the full width of the filter. The pitch of the helically wound stiffening element can, in this context, correspond to the simple rib spacing of adjacent ribs or crests, although it can also differ from this, then preferably being an integral multiple thereof. Where appropriate, the stiffening element can also intersect the crests on the top side or underside of the filter. This is not the case in the practical example, the stiffening element extending, starting from a valley on a face end, to the nearest crest. In this context, the stiffening elements pass, at the level of the crests, over the top edge or the greatest depth area 34 (see FIG. 9) of the respective step 32, thus being secured against displacement on both sides. The filter can thus be stabilized by a single stiffening element, although more can also be provided.

It goes without saying that, in all embodiments of the filter, the profiles can also be of asymmetrical design, i.e. with different widths and/or inclinations of the profiles on either side of the respective apexes or crests.

FIGS. 12a, b show an enlarged representation of step 32 according to FIG. 9, where it is illustrated that the area of indentation 31, which represents a flattening of the further inward-lying filter pocket in that the adjacent filter walls are in contact with each other, can essentially constitute a 90′ step. Crest 42 of the corrugation, which is of zigzag design according to the practical example, thus runs parallel to crest 43 of the flattened area. Advantageously, the minimum depth T of the indentation corresponds to the product of width a of the profile and sine a of the bend of the filter wall, measured from the adjacent valley (a×sin α), at most preferably the product of a×sin 45°. It goes without saying that the same also applies to wave-like profiling of the filter wall to form arc-shaped crests and valleys.

As illustrated in FIG. 12b, step 32 can also display arc-shaped transitional areas 32a of the step to indentation 31 and to adjacent filter wall 44, which forms a filter pocket.

FIGS. 13 to 16 show a particle filter that is essentially formed by folding of a filter material strip according to FIG. 9, where further details will be described below, although these can also be realized in connection with other embodiments, such as the practical examples according to FIGS. 17 and 18 in particular, or also according to all other practical examples, insofar as they are expedient there.

According to FIGS. 13 and 16, the filter displays at least two different types of stiffening element 45, 46, where a first type of stiffening element 45 is located in filter pockets 47, open on the inflow side, and the second type of stiffening element 46 in filter pockets 48, located on the outflow side, where the filter pockets are in each case formed by adjacent filter walls, connected to each other by deflection areas 10. In this context, FIGS. 16a, 16b show cross-sectional views of the filter according to FIG. 13 at the level of line A-A (FIG. 16, left) and at the level of line B-B (FIG. 16, right). Stiffening elements 45 display a lesser stiffness or stiffening effect on adjacent filter walls, stiffening elements 46 displaying a greater stiffening effect. As a result, with only little material input and a minor change in the flow conditions, the outflow side of the filter can be stabilized to a greater extent than the likewise stabilized inflow side, since the pressure of the fluid medium on the filter walls is greater on the inflow side than on the outflow side, meaning that the filter walls are pressurized towards the outflow side. As a result, the fluid medium can essentially be passed through slit-like flow ducts 49a on the inflow side, where the slits extend transverse to the direction of flow, and essentially through one-dimensional flow ducts 49b on the outflow side, because, in this instance, wave-like stiffening elements 45 on the inflow side extend over only a short extension L_{E}, while stiffening elements 46 extend over a longer extension L_{A}, virtually the full filter length in this instance. The passage of the fluid medium through the filter walls is represented in FIG. 13 by the bent arrows.

According to FIG. 14, face-end flat areas 50 of the filter pockets, which are formed by adjacent filter walls, are inclined relative to the longitudinal direction of the filter, meaning that favorable flow conditions are present even if the fluid medium flows against the filter at an angle (see bent ar-rows). Essentially one-dimensional stiffening elements 51 can be inserted, passing through the layers, in the area of flat areas 50, where the adjacent filter walls of the double layer are in plane contact with each other. A particle-tight design is possible because the flat areas are located outside filter pockets 52 and the filter walls lie closely against each other.

It goes without saying that the stiffening elements according to FIGS. 13, 16 are not limited to strips or sheet-metal layers with a wave-like or zigzag structure, but can, for example, also be designed in the form of layers of expanded metal or in some other, suitable way. This applies to all embodiments according to the invention in which slit-like filter pockets are provided.

According to FIG. 15, filter walls 2 can be slightly inclined relative to the longitudinal direction of the filter or the direction of flow of the fluid medium (see arrow D), where the width of filter pockets 47 in stacking direction S, which corresponds to the direction in which the strip deposited in meandering fashion is deposited, can be identical or different on the inflow side and the outflow side. As a result of the inclined arrangement of the filter walls (FIG. 15, top), the inflow-side filter volume of the particle filter, which is defined by filter pockets 47 open on the inflow side, can be greater than the outflow-side volume of filter pockets 48, e.g. in a ratio of 60:40 to 100:50 or more. Favorable flow or pressure conditions can be realized in the filter as a result.

FIGS. 19 and 20 illustrate a further embodiment of the strip, with ribs running in the direction of flow, which can be folded in zigzag fashion, or also corrugated in arc-like fashion. Structuring is accomplished in the form of a single sheet-metal layer according to FIG. 19, and in the form of a strip deposited in meandering fashion that displays steps 32 at the level of deflection areas 10 and indentations 35, corresponding to steps 32 of the practical example according to FIG. 9. According to FIGS. 19 and 20, the strip is structured in such a way that crests 51, provided at the level of a face end or side wall of the particle filter, e.g. inflow side 50a, transition into valleys 52 along the direction of flow or the longitudinal direction of the filter, meaning that the crest or its wave back 17a formed by the folding line drops away towards outflow side 50b. To this end, a first group of folding lines 53 is formed that runs parallel to the longitudinal direction of the filter or the direction of flow of the fluid medium, where, on both sides of line 53, opposite second and third groups of folding lines 54 and 55 are provided, which each run towards each other, are each located between two lines 53, and intersect line 53 at least roughly at the level of the filter face ends. Groups of folding lines 54, 55 thus connect crests located on the inflow side to crests located on the outflow side. As a result, flow-deflecting means are provided for the fluid medium, which create a flow component in the transverse direction to the longitudinal direction of the particle filter, where the slit-like filter pockets can display an essentially constant or exactly constant filter wall spacing over the width of the filter, to which end the individual layers of the filter walls are designed congruently to each other, although an inverse arrangement is also possible.

FIG. 21 shows various designs of stiffening elements, which are of one-dimensional or zero-dimensional (FIG. 21b) design here. The stiffening elements can, in particular, be designed in the form of wires, strips, or also strips of sheet metal layer or strip-like layers of expanded metal, without being limited to this.

According to FIG. 21a, stiffening elements 60a, which run essentially parallel to the principal planes of the filter walls, penetrate the filter walls at the level of double layers that are separated from the filter pockets set back by step 62 and thus create a particle-tight embodiment, as well as stiffening elements 60b running essentially perpendicularly to the principal planes of the filter walls, where the filter can in each case also be equipped with only one type of stiffening element, at least at the respective face end. Where appropriate, stiffening elements 60a can also lie on wave-shaped flat areas 62. The stiffening elements can in each case be passed loosely through the filter walls, coated, or connected to the filter walls in tensile force-absorbing fashion, e.g. by subsequent twisting, by spot-welded connections, by non-positive connections, such as folded seam connections, or the like.

According to FIG. 21b, in the area of the double layers of filter walls 63a, 63b, which are in close, preferably particle-tight contact, or on indentations 35, tabs 65 are notched out, which are clamped in areas of the opposite filter walls or support them, in the undersides of the crests according to the practical example. The succession of zero-dimensional stiffening elements in the form of notched-out tabs 65 results overall in the formation of one-dimensional stiffening structures. Once again, the notched tabs are separated from filter pockets 63.

FIG. 21e shows one-dimensional stiffening elements in the form of strips 66, which are connected to the filter walls by spot-welded connections 67. In this context, the strips lie on flat areas 68 and can directly support the underside of the filter wall of the adjacent double layer lying above them.

FIG. 21f shows an arrangement with a one-dimensional stiffening element, in the form of strip 69 in this case, some areas of which are provided with insulating areas 69a, e.g. by means of ceramic coatings. As symbolized, these strips can be designed as heating elements.

Stiffening elements 60a, b, 65, 66, 69 are each preferably located in the area of the face ends. The stiffening elements can in each case be coated with catalytic material, particularly if they constitute separate stiffening elements, although the stiffening elements can also be designed as heating devices, particularly if they are designed to be electrically insulating, e.g. by coating, oxidation or the like.

FIG. 22a shows an embodiment of filter walls 70 with lateral areas 71, bent down relative to the principal direction of extension thereof, which are likewise connected to each other by continuous, face-end deflection areas 72 and form a double layer 71a, 71b with layer areas 71a and 71b lying in close and particle-tight contact. This makes it possible to create particle-tight side walls of the filter, which can extend over the full length and/or height of the filter, but also only over part thereof, where appropriate, e.g. in order to form stiffening elements. This design is not limited to the illustrated, inverse arrangement of the filter walls and the illustrated design of the indentation, which corresponds to strip folding according to FIG. 8, but is independent thereof.

According to FIG. 22a, top, the deflection of lateral areas 71 can essentially take place in the area of valleys 73, and according to the section illustrated in FIG. 22b, bottom, also at the level of crests 74, or generally the apex of the rib-like strip structure. It goes without saying that the corrugation can in each case also be of arc-shaped design and that web-like areas 75 on the deflection areas can be missing, or display different heights on the inflow side and the outflow side. One-dimensional stiffening elements 76, in the form of wires in this instance, are likewise bent down. The stiffening elements can be fastened to side walls 71 in tensile force-absorbing fashion, e.g. by clamping at clamping points 77, or fixed in place on a housing in tensile force-absorbing fashion. Stiffening elements 76, 66 can also be provided with catalytically active material.

According to FIG. 22b, the bent-down lateral areas can also display notches 80, where preferably only upper layer 78a is notched on each double layer 78a, b, meaning that a continuous, particle-tight side wall remains beneath it. The notches can serve to fasten the filter on a housing. It goes without saying that the design of the notched side walls is not limited to the strip profiling illustrated in FIG. 22b.

FIGS. 23a, 23b show deflection of the strip by kink 90, which is formed, starting from a crest 17, by pairs of kinking lines 92, 93, which extend towards the inflow side and the outflow side, diverge and preferably intersect at the level of valleys 18. This results in the formation of rhombic areas 95. Overall, this enables the filter (see FIG. 23b) to display areas 8a, 8b, whose directions of flow enclose an angle relative to each other, as a result of which vertical offset HV is produced in the direction of flow. In this context, the entire filter is still formed by a single, continuous strip 7. Housing 11 can be designed in the manner of an elbow in this context. It goes without saying that this flow deflection is also possible with other filter strip profiles.

FIG. 24 shows a further variant of a particle filter, in which filter material strip 100 is folded along folding line 101, running parallel to the longitudinal direction of the strip, forming a double layer in reference to the folding line that forms a deflection area located at the face end, i.e. on the inflow side, or—according to the practical example—on the outflow side. Sections through the arrangement according to FIG. 24a along lines A-A, B-B and C-C are shown in FIGS. 24b-d, with an additional housing in FIG. 24d. The free lateral edges of the filter strip are each produced with lateral edges of an adjacent double layer, forming folds 104, also by means of welded connections, where appropriate, which seal the filter pockets in particle-tight fashion. In this context, connecting areas 102, 103 of the edge areas of filter walls of adjacent double layers, following on from each other on the inflow side or, where appropriate, also on the outflow side instead, can, as illustrated, be arranged to project or recede relative to each other. Thus, in keeping with the terminology of the invention, filter walls 101a and 101b are assigned to the same double layer, and filter walls 101b and 101c to different double layers. Located downstream of the folds are flat contact areas 105 of adjacent filter walls for increasing the particle-tightness. The direction of flow of the fluid medium through filter pockets 106, formed by the double layers, is symbolized by the bent arrows.

The filter material strip doubled in this way is deposited in meandering fashion according to FIGS. 24a,b, forming a cylindrical or semicylindrical particle filter segment, in which deflection areas 107 of greater width are provided radially on the outside, and narrow deflection areas 108 on a central axis on the inside. The strip deposited in meandering fashion is thus rolled up about longitudinal axis 100a of the filter. As illustrated in FIG. 24d, the fluid medium can enter the filter pockets not only through face end 109, but also from radially outwards via the area of the filter pocket assigned to deflection area 107, and can escape through the face-end filter pockets on the outflow side. The particle filter can thus be designed as a completely cylindrical filter in one piece. Where appropriate, deflection areas 101 can also be located on the inflow side. Formed on radially outward-lying deflection areas 107 are tabs 110, projecting at the face end, or also radially, by means of which the filter can be fastened to housing 111 in particle-tight fashion, e.g. clamped in housing pocket 112.

According to FIG. 25, the particle filter can be formed from a strip 7 deposited in meandering fashion, corresponding to FIG. 9, where inflow direction E and outflow direction A can enclose an angle relative to each other, e.g. of approx. 90°, and/or where several inflow sides enclosing angles relative to each other can be provided. In this context, inflow into slit-like pockets 115 can take place transversely to longitudinal direction L of the strip, e.g. from the direction of opposite areas. Where appropriate, one or both lateral inflow sides E can also be closed. To this end, lateral areas 112 of the strip can be connected to each other in particle-tight fashion, e.g. folded over or flanged. The side of the filter opposite outflow side 113 can be of open design, forming flow ducts 114, which can be of one-dimensional or slit-like design, although it can, as illustrated, also be sealed in fluid-tight fashion by plate 116 or the like. Filters of this kind can be used as manifolds, in particular.

1. Particle filter, especially for exhaust gases of diesel-fuelled internal-combustion engines, with a plurality of filter walls to be flowed through, with filter surfaces made of filter material that are permeable to a fluid and essentially impermeable to particles entrained by it and to be separated, where the filter displays an inflow side and an outflow side and the filter can be flowed through by the fluid in one direction of flow, where the filter walls consist of a fabric that can be structured by deformation and are connected to each other in at least essentially particle-tight fashion on the inflow side and the outflow side of the filter, characterized in that, the plurality of filter walls of the filter, or of a filter segment displaying a plurality of filter walls, is formed by a continuous strip of filter material that is deposited to form a three-dimensional body, forming deflection areas in the process, which displays slits, at least over part of its length, extending at least essentially over the full width or the full radius of said body.

2. Particle filter according to claim 1, characterized in that the slits extend with an essentially constant slit height over at least essentially the full filter length in the direction of flow of the fluid.

3. Particle filter according to claim 1, characterized in that the slit height increases or decreases in the direction of flow towards the outflow end.

4. Particle filter according to claim 1, characterized in that, on at least the inflow side or the outflow side of the filter, adjacent filter walls are connected to each other by a continuous deflection area of the strip-like filter material located on the inflow side and/or the outflow side.

5. Particle filter according to claim 1, characterized in that the continuous strip of filter material is deposited in meandering fashion to form a three-dimensional body.

6. Particle filter according to claim 5, characterized in that the strip of filter material deposited in meandering fashion is folded along at least one folding line running essentially parallel to the longitudinal direction (L) of the strip, forming at least a double layer, and is deposited in meandering fashion in such a way that the longitudinal direction of the strip runs transversely to the direction of flow of the fluid medium, and in that the folding line running in the longitudinal direction of the strip is located on the inflow side or the outflow side.

7. Particle filter according to claim 1, characterized in that edges of the strip, which are located opposite the folding line, run in the longitudinal direction of the strip and are assigned to one double layer referred to the folding line, are connected in essentially particle-tight fashion to sections of the strip that are assigned to an adjacent double layer.

8. Particle filter according to claim 1, characterized in that the width of the strip exceeds the width of the filter, at least in some areas, and in that edge-side areas of the strip are bent down on at least one, or both, of the lateral strip edges, forming connections between different filter walls, or forming a side wall of the filter extending at least partly between the inflow side and the outflow side.

9. Particle filter according to claim 8, characterized in that notches are provided in one layer of the strip of filter material in the area of adjacent filter walls of a double layer, preserving one continuous filter wall, and in that the notches are bent out of the layer of the strip towards an adjacent filter wall, or arranged to extend laterally outwards from the filter.

10. Particle filter according to claim 1, characterized in that the structures of adjacent filter walls are essentially congruent or essentially inverse in relation to each other.

11. Particle filter according to claim 1, characterized in that adjacent filter walls are structured to form ribs running essentially in the direction of flow, and adjacent filter walls are deposited consecutively on top of each other in the manner of a stack and a distance apart in a stacking direction, and in that flat areas are provided that reduce the filter wall spacing, these being located on the face end of the filter and designed in the form of indentations extending into the interior of the filter from the associated face end.

12. Particle filter according to claim 1, characterized in that the filter walls display structures running in the direction of flow in the form of filter wall corrugations, forming crests and valleys and wave backs extending in the longitudinal direction of the filter, and in that the wave backs of some of the corrugations are inclined relative to the direction of flow in such a way that, along them, a crest located on a face end transitions into a valley located on the opposite face end.

13. Particle filter according to claim 1, characterized in that the deflection areas of the filter material strip on the inflow side and/or the outflow side display a height transverse to the direction of flow through the filter, such that adjacent filter walls are separated from each other by the deflection areas at the face end.

14. Particle filter according to claim 1, characterized in that the filter is designed as an essentially cylindrical or semicylindrical filter body with a longitudinal filter body axis, which is manufactured from a strip of filter material, folded in the longitudinal direction to form a double layer and deposited in meandering fashion, and in that the strip deposited in meandering fashion is folded around the filter body longitudinal axis, forming deflection areas located on the cylindrical or semicylindrical perimeter.

15. Particle filter according to claim 1, characterized in that elongated stiffening elements are provided, which are located between the layers of the filter material strip, penetrate the layers of the strip and/or are located on the face end of the filter.

16. Particle filter according to claim 15, characterized in that at least one stiffening element is provided, which extends around the full circumference of the filter and runs transversely to the direction of extension of the filter walls.

17. Particle filter according to claim 1, characterized in that structural elements with catalytically active material are provided between or on the filter walls for catalytic conversion of at least one component of the fluid medium and/or the particles.

18. Particle filter according to claim 1, characterized in that the strip of filter material displays integrally molded strips of material other than the filter material on one or both sides.

19. Particle filter according to claim 1, characterized in that the inflow-side volume of the particle filter is greater than/equal to 1.5 times the outflow-side filter volume.

20. Particle filter according to claim 1, characterized in that inflow slits for the fluid, formed on the inflow side between adjacent filter walls, are provided, and in that the slit width decreases towards the interior of the particle filter and, a distance away from the inflow-side face end, the filter walls bordering the slit are designed to contact each other in some areas, forming essentially one-dimensional flow ducts.

21. Particle filter according to claim 1, characterized in that at least one or two inflow sides (E) are provided, which permit inflow of the fluid into the particle filter from different directions, the fluid entering flow-deflecting ducts for the fluid, formed between adjacent filter walls, and in that at least one outflow side (A) is provided, through which the fluid emerges from the particle filter in a direction different from at least one or both of the inflow directions.

22. Particle filter according to claim 1, characterized in that the direction of flow of the fluid medium is transverse to the longitudinal direction of the flow ducts or rib-like structures at the level of the inflow side of the particle filter, and in the longitudinal direction of the flow ducts or rib-like structures of the particle filter when emerging from the outflow side (A).

23. Particle filter with a plurality of filter walls to be flowed through, with filter surfaces made of filter material that are permeable to a fluid and essentially impermeable to particles entrained by it and to be separated, where the filter displays an inflow side and an outflow side and the filter can be flowed through by the fluid in one direction of flow, where the filter walls consist of a fabric that can be structured by deformation and are connected to each other in at least essentially particle-tight fashion on the inflow side and the outflow side of the filter, where the filter is designed as an essentially cylindrical or semicylindrical filter body with a longitudinal filter body axis, which is manufactured from a strip of filter material deposited in meandering fashion, where the strip deposited in meandering fashion is folded around the filter body longitudinal axis, forming deflection areas located on the cylindrical or semicylindrical perimeter.

24. Particle filter with a plurality of filter walls to be flowed through, with filter surfaces made of filter material that are permeable to a fluid and essentially impermeable to particles entrained by it and to be separated, where the filter displays an inflow side and an outflow side and the filter can be flowed through by the fluid in one direction of flow, where the filter walls consist of a fabric that can be structured by deformation and are connected to each other in at least essentially particle-tight fashion on the inflow side and the outflow side of the filter, and where at least one or two inflow sides are provided, which permit inflow of the fluid into the particle filter from different directions, the fluid entering flow-deflecting ducts for the fluid, formed between adjacent filter walls, and where at least one outflow side is provided, through which the fluid emerges from the particle filter in a direction different from at least one or both of the inflow directions.
